(19) United States
(12) Patent Application Publication
(10) Pub. No.: US 2009/0114864 A1
(43) Pub. Date: May 7, 2009

(54) Failsafe fuel doser solenoid valve using a reversible electrical coil assembly

(75) Inventor: Mark Allen Scheffer, Livonia, MI (US)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 11/982,773

(22) Filed: Nov. 5, 2007

(51) Int. Cl. F16K 31/06

(52) U.S. Cl. 251/129.15

(57) ABSTRACT

A method is provided to reduce the risk that an exhaust line reductant dosing system comprising a pulse width modulated solenoid valve will leak reductant into the exhaust. The method comprises powering the solenoid's electrical coil with a current reversed from the primary direction. The resulting magnetic field exerts a force on the valve pintel in the same direction as that exerted by the solenoid's spring. The additional force of the magnetic field can correct situations in which the valve pintel does not properly engage the valve seat.

### FIELD OF THE INVENTION

The present invention relates to exhaust line dosing systems for exhaust aftertreatment systems.

### BACKGROUND

Exhaust line dosing systems are used to provide reductant to diesel and lean burn engine exhaust in processes for mitigating particulate matter and NOₓ emissions. Both particulate matter and NOₓ are pollutants that manufacturers and researchers have put considerable effort toward reducing. Particulate matter is generally removed from exhaust using diesel particulate filters. To regenerate the filters, reductant is generally provided to the exhaust to combust and heat the filters to ignition temperatures. NO_{X} can be removed from diesel engine exhaust by any of several methods, all of which require provision of reductant to the exhaust. The approaches include lean-burn NO_{X} catalysis, selective catalytic reduction (SCR), and lean NO_{X} trapping.

Lean-burn NO_{X} catalysts promote the reduction of NOₓ under oxygen-rich conditions. A reductant must be steadily supplied to fuel the reaction. Lean-burn NO_{X} catalysis, with the exception of ammonia SCR described below, is not a preferred technique for NO_{X} removal in that the removal rates over long periods of operation are unacceptably low.

SCR generally refers to selective catalytic reduction of NO_{X} by ammonia. SCR can achieve high levels of NO_{X} reduction, although the difficulty of providing a suitable infrastructure for ammonia distribution and the risk of releasing ammonia into the environment are causes for concern. SCR requires continuous or near continuous dosing of ammonia, or a suitable precursor, into the exhaust line.

Lean NO_{X} traps (LNTs) are devices that adsorb NO_{X} under lean exhaust conditions and reduce and release the adsorbed NO_{X} under rich conditions. An LNT generally includes a NO_{X} adsorbent and a catalyst. The adsorbent is typically an alkaline earth compound, such as BaCO₃ and the catalyst is typically a combination of precious metals including Pt and Rh. In lean exhaust, the catalyst speeds oxidizing reactions that lead to NO_{X} adsorption. In a reducing environment, the catalyst activates reactions by which hydrocarbon reductants are converted to more active species and reactions by which adsorbed NO_{X} is reduced and desorbed. In a typical operating protocol, a reducing environment is created within the exhaust from time-to-time to regenerate (denitrate) the LNT.

The reducing environment for LNT regeneration can be created in several ways. Reductant can be injected into the exhaust by the engine fuel injectors. For example, the engine can inject extra fuel into the exhaust within one or more cylinders prior to expelling the exhaust. A disadvantage of this approach is that engine oil can be diluted by fuel passing around piston rings and entering the oil gallery. Additional disadvantages of cylinder reductant injection include having to alter the operation of the engine to support LNT regeneration, excessive dispersion of pulses of reductant, and forming deposits on turbocharger and EGR valves. As an alternative to using the engine fuel injectors, reductant can be injected into the exhaust downstream from the engine using a separate exhaust line dosing system.

An oxidation catalyst or a fuel reformer may be used within the exhaust line to combust or reform the injected reductant upstream from a pollution control device. U.S. Pat. No. 7,082,753 (hereinafter “the '753 patent”) describes an exhaust aftertreatment system with a fuel reformer placed in the exhaust line upstream from an LNT. The reformer includes both oxidation and reforming catalysts. The reformer both removes excess oxygen from the exhaust and converts the hydrocarbon reductant into more reactive reformate. The inline reformer of the '753 patent is designed to heat rapidly and to then catalyze steam reforming reactions.

Temperatures from about 500 to about 700° C. are required for steam reforming. These temperatures are substantially higher than typical diesel exhaust temperatures. To achieve a sufficient reformer temperature when LNT regeneration is required, the reformer of the '753 patent is heated by first injecting hydrocarbon at a rate that leaves the exhaust lean, whereby the injected hydrocarbon combusts in the reformer, releasing heat. After warm up, the hydrocarbon injection rate is increased to provide a rich exhaust. Ideally, the reformer of the '753 patent can be operated auto-thermally, with endothermic steam reforming reactions balancing exothermic combustion reactions. In practice, however, at high exhaust oxygen concentrations the reformer heats excessively if reformate is produced continuously. To avoid overheating, the '753 patent proposes pulsing the hydrocarbon injection. The reformer cools between pulses.

In each of these systems, control of the exhaust line dosing rate is important. Inaccurate control of exhaust line dosing can result in reductant breakthrough, inadequate emission control, or overheating of exhaust aftertreatment devices. Control must be maintained over long periods in the hostile environment of a vehicle exhaust system. Vibration tolerance, tolerance of high exhaust line temperatures, and resistance to hydrocarbon coking between injections must all be considered.

In spite of advances, there continues to be a long felt need for an affordable and reliable diesel exhaust aftertreatment system that is durable, has a manageable operating cost (including fuel penalty), and reduces NO_{X} and particulate matter emissions to a satisfactory extent in the sense of meeting U.S. Environmental Protection Agency (EPA) regulations effective in 2010 and other such regulations.

### SUMMARY

The inventor has found that over long periods of operation an exhaust line dosing system comprising a pulse width modulated solenoid flow control valve may leak due to improper seating of the valve pintel. Moreover, the inventor has determined that such improper seating can be mitigated by applying a reverse current to the solenoid's electrical coil, whereby the magnetic force of the coil combines with the force of the solenoid's spring to drive the pintel into a properly seated position.

Accordingly, one of the inventor's concepts relates to a method of operating an exhaust line dosing system. The exhaust line dosing system comprises a pulse width modulated solenoid flow control valve having the following components:

a valve body;

an orifice;

a valve seat surrounding the orifice;

a sealing member configured to move within the valve body between a lowered first position in which the sealing member engages the valve seat to seal off the orifice and a second position in which the sealing member is lifted from the valve seat allowing reductant under pressure within the valve body to release through the orifice;

a spring that biases the sealing member toward the first position;

a permanent magnet integral with or attached to the sealing member; and

an electrical coil that when powered with a direct current in a primary direction maintains a magnetic field that exerts a force on the permanent magnet that lifts the sealing member away from the first position and toward the second position. The method comprises controlling the duty cycle of the pulse width modulated flow control solenoid valve to dose reductant from a pressurized source through the orifice and providing a direct current to the electrical coil in a reverse direction from the primary direction in order to ensure that the sealing member properly engages the valve seat.

The primary purpose of this summary has been to present certain of the inventor's concepts in a simplified form to facilitate understanding of the more detailed description that follows. This summary is not a comprehensive description of every one of the inventor's concepts or every combination of the inventor's concepts that can be considered “invention”. Other concepts of the inventor will be conveyed to one of ordinary skill in the art by the following detailed description together with the drawings. The specifics disclosed herein may be generalized, narrowed, and combined in various ways with the ultimate statement of what the inventor claim as his invention being reserved for the claims that follow.

### BRIEF DESCRIPTION OF THE DRAWINGS

FIG. 1 is a schematic illustration of an exemplary exhaust line dosing system in which concepts of the inventor can be implemented.

FIG. 2 is a schematic illustration of a power generation system showing a use to which a exhaust line dosing system as conceived by the inventor is adapted.

FIG. 3 is an illustration of a solenoid valve that can be operated according to the inventor's concepts.

FIG. 4 is a diagram of an exemplary circuit that can be used to operate a solenoid valve as conceived by the inventor.

### DETAILED DESCRIPTION

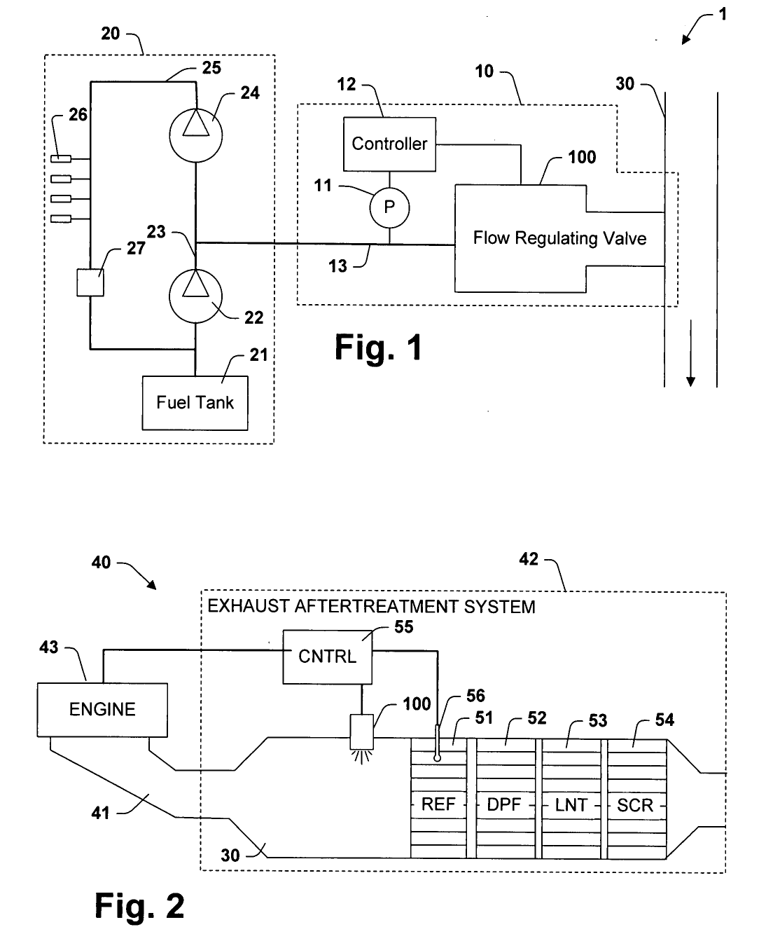

FIG. 1 is a schematic illustration of an exemplary exhaust line dosing system 10 that is part of a power generation system 1 that can embody some of the inventor's concepts. The exhaust line dosing system 10 draws fuel from an engine fuel supply system 20 and injects the fuel into an exhaust line 30. The exhaust line dosing system 10 includes a flow regulating valve 100, a pressure sensor 11, and a controller 12. The pressure sensor 11 is configured to read the pressure in a fuel supply line 13, which carries hydrocarbon from a lower pressure portion of the engine fuel supply system 20 to the flow regulating valve 100.

The flow regulating valve 100 is adapted to selectively admit fluid from a pressurized source. In this example, the pressurized source is the low pressure portion of the engine fuel supply system 20. Alternatively, the pressurized source could be a pump provided as part of the exhaust line dosing system 10. In general, the pressurized reductant source will provide a pressure from about 2.0 to about 8.0 bar gauge pressure. These pressures can be provided with readily available electrical low pressure fuel pumps, optionally in conjunction with a pressure intensifier. The reductant is expected to be liquid.

The engine fuel supply system 20 has a low pressure fuel pump 22 that pumps fuel from a tank 21 to a conduit 23. The conduit 23 connects to a high pressure fuel pump 24, which supplies a high pressure common rail 25. Fuel injectors 26 admit fuel from the common rail 25 to the cylinders of a diesel engine 43, which is operative to produce the exhaust carried by the exhaust line 30. A high pressure relief valve 27 can return fuel from the common rail 27 to the fuel tank 21.

Drawing fuel for exhaust line fuel injection from the conduit 23 has the advantage of eliminating the need for an additional fuel pump separate from the engine fuel supply system 20, but has the disadvantage that the pressure in the conduit 13 varies significantly during normal operation of the engine 43. The pressure in the conduit 13 is measured by the pressure sensor 11 for use by the controller 12 in controlling the flow regulating valve 100

The flow regulating valve 100 is specifically adapted to meet the demands for exhaust line reductant dosing created by one or more pollution control devices configured within the exhaust line 30. FIG. 2 provides a schematic illustration of an exemplary power generation system 40 comprising the exhaust line 30 with several exemplary pollution control devices. The power generation system 40 includes an engine 43, a manifold 41 that guides exhaust from the engine 43 to the exhaust line 30, and a controller 55 that controls the exhaust line dosing system 100 based on data such as data from the temperature sensor 56. The controller 55 can be the same unit as the controller 12 or a separate unit that issues instructions to the controller 12. Likewise, the controller 55 can be an engine control unit (ECU) or a separate device that communicates with the ECU.

The exemplary exhaust line 30 includes a fuel reformer 51, a diesel particulate filter 52, an LNT 53, and an SCR catalyst 54. The exhaust line reductant dosing system 100 is used intermittently to warm the fuel reformer 51, to heat the DPF 52, and to provide reductant for the fuel reformer 51 to remove oxygen from the exhaust and produce reformate to regenerate the LNT 53. The exhaust line reductant dosing system 100 may also be used to provide reductant in pulses over an extended period of time, as when fuel injection is pulsed to regulate the temperature of the reformer 51 over extended periods of desulfating the LNT 53.

The exhaust line reductant dosing system 100 is typically designed to accurately dose reductant to the exhaust line 30 over a broad range of rates in order to fulfill one or more of the foregoing functions. A broad range typically spans two orders of magnitude. For heavy duty diesel engines, exemplary ranges are from about 20 to about 1200 grams per minute and from about 25 to about 650 grams. For a medium duty diesel engine, from about 20 to about 800 grams per minute is typical. For an automotive engine, from about 20 to about 400 grams per minute is typical. Relatively low reductant dosing rates are used to heat the reformer 51 and downstream devices. Relatively high reductant injection rates are used to make the exhaust rich for regenerating the LNT 53. The accuracy of reductant injection rate control is preferably to within about ±5% of the full scale over the entire range, more preferably to within about ±3%, ad even more preferably to within about ±1%.

The exhaust line reductant dosing system 100 preferably remains operative as the exhaust line temperature varies from about 110° C. to about 550° C. Operability at these temperatures includes the property of the exhaust line reductant dosing system not being adversely affected over the extended periods between reductant injections. Between dosing periods, stagnant reductant within the flow regulating valve 100 can thermally decompose and eventually clog the flow regulating valve 100. To prevent the stagnant reductant from being excessively heated, the flow regulating valve 100 is preferably provided with a cooling means.

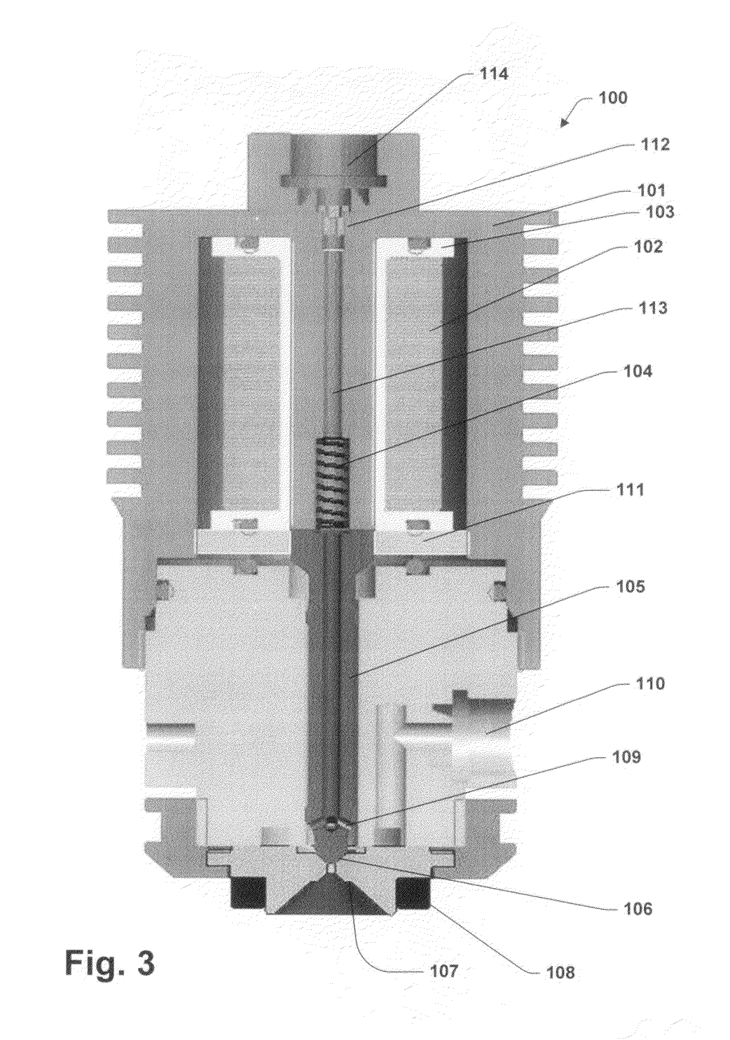

FIG. 3 is an illustration of an exemplary flow regulating valve 100. The flow regulating valve 100 is a solenoid operated needle valve. Fuel under pressure is admitted to the valve body 101 through inlet 110. From the valve body, fuel under pressure is released through orifice 107 when the pintel 105 is lifted off the valve seat 106, which is formed into the valve body 101 and surrounds the orifice 107. The valve 100 need not be a needle valve comprising a pintel. Any type of solenoid operated pulse width modulated valve can be used instead. Any type of sealing member can be used in place of the pintel 105.

The pintel 105 is moved by a solenoid. The solenoid comprises a spring 104 that biases the pintel 105 against the valve seat 106. When properly seated, the pintel 105 forms a fluid tight engagement with the valve seat 106, preventing fluid from flowing from within the valve body 101 out the orifice 107.

The solenoid also comprises an electrical coil 102 wound about spool 103. When powered with a current in a primary direction, the coil 102 exerts a magnetic field that operates on a permanent magnet 111. The permanent magnet is integral with or connected to the pintel 105. The magnetic force overcomes the spring force and lifts the pintel 105 off the valve seat 106.

For purposes of this application, the term “energizing” will be used to describe the transitional step of changing the voltages applied to the ends of the coil 102 and thereby altering the current through the coil 102. “Powered” will be used to describe the resulting state in which a current is flowing steadily through the coil 102 thereby maintaining a magnetic field.

The flow regulating valve 100 is a pulse width modulated (PWM) valve. A pulse width modulated valve is one that controls the flow rate by opening and closing rapidly. The flow rate is approximately proportional to the fraction of the time the valve is open. The fraction of the time the valve is open is determined by the duty cycle, which includes the frequency of opening and closing and the fraction of each period the valve spends open. In a typical PWM valve, the valve alternates between fully open and fully closed positions with each period.

The valve lift for this system is typically quite small. Lift is the distance the pintel 105 rises of the seat 106. Typically, the valve lift is from about 100 to about 1000 microns, commonly being from about 200 to about 300 microns. The momentum built by the pintel 105 during such short periods of opening and closing is generally negligible. Accordingly, this flow control valve 100 is generally not of a type in which it might be beneficial to apply a reverse current to slow the movement of the pintel 105 in order to reduce the impact force and resulting wear. Likewise, reversing the current does nor generally have any significant effect on the valve turn-down ratio, which relates to the speed at which the valve can be opened and closed.

Particularly when the lift is small, the flow rate through the valve 100 when the valve pintel 105 is lifted may be limited by the flow rate through the gap between the pintel 105 and the valve seat 106. In such circumstances, the flow rate depends on the lift. Unless the lift is limited by a stop, the lift is proportional to the current provided to the electrical coil 102. If the gap formed between the valve pintel 105 and the valve seat 106 is large in comparison to the size of the orifice 107, the flow rate is independent of lift and depends instead on the size of the orifice 107.

The tolerances of the system must be relatively high. A typical exhaust line injection system is designed to operate over 500,000 vehicle kilometers. Over such periods, significant wear can occur. The pintel 105 and surrounding parts must be operable through thermal expansions over a range of temperatures, even when the flow control valve 100 is cooled. In addition, deposits may form on or adjacent to the pintel 105. Accordingly, the tolerances between the pintel 105 and adjacent parts are typically from about 25 to about 250 microns and preferably from about 50 to about 100 microns.

The inventor has found that a flow control valve of this type, of this size, with these tolerances, under these conditions may sometimes leak. The inventor determined that the cause of such leakage was improper seating of the fully lowered pintel 105 on the valve seat 106. A fully lowered pintel 105 is one that has engaged the valve seat 106 or some adjacent portion of the valve body 101 that resists further descent of the pintel 105 from its lifted position. Finally, the inventor discovered that an improperly seated pintel 105 not forming a fluid-tight seal could be seated properly to form a fluid tight seal by applying a reverse current to the solenoid 102. The reverse current drives the magnet 111 with a magnetic field reversed from the usual orientation. Under the reverse magnetic field, the magnet 111 and the spring 104 drive the pintel 105 in the same direction. The addition of the magnetic driving force to the spring force causes the pintel 105 to move into a properly seated position.

The coil 102 can be energized with a reverse current at any suitable time and the reverse current can be maintained for any suitable period consistent with the function of ensuring proper seating of the pintel 105. In one embodiment, the coil 102 is energized with the reverse current after the pintel 105 is fully lowered. In the fully lowered position, the pintel 105 is pressed against the valve seat 106 or some nearby part of the valve body 101. Alternatively, the coil 102 can be energized with the reverse current as the pintel 105 is lowering. The reverse current is then maintained until after the pintel 105 has seated. The reverse current may be maintained for a long period between periods of pulse width modulated flow control. One second or more is considered a long period.

The reverse current can be applied in any suitable fashion. For example, the current can be reversed using a polarity switch, which reverses the electrical connections between the two ends of the electrical coil 102. This approach is simple, but is unsuitable if one end of the coil 102 is grounded to the valve body 101, as is common. If one end of the coil 102 is grounded, the current can be reversed by switching the voltage supplied to one end. For example, if the voltage used to provide the primary current is above ground, the voltage used to apply the reverse current will be below ground. A variety of circuits can be used to obtain a source for the reverse current voltage by transforming the voltages that are available.

A circuit used to provide a reverse current voltage may also be suitable to provide a variable voltage for the primary current. If the flow rate through the valve is dependent on the valve lift and the valve lift is not limited by a stop, varying the voltage for the primary current can be used to affect the flow rate through the valve. Small voltages drops across the coil 102 can be used when low flow rates are desired and high voltage drops can be used when large flow rate are desired. This increases the turndown ratio for the valve 100 in comparison to the turndown ratio available by varying just the duty cycle. Large turndown ratios are desirable in many exhaust line reductant dosing applications.

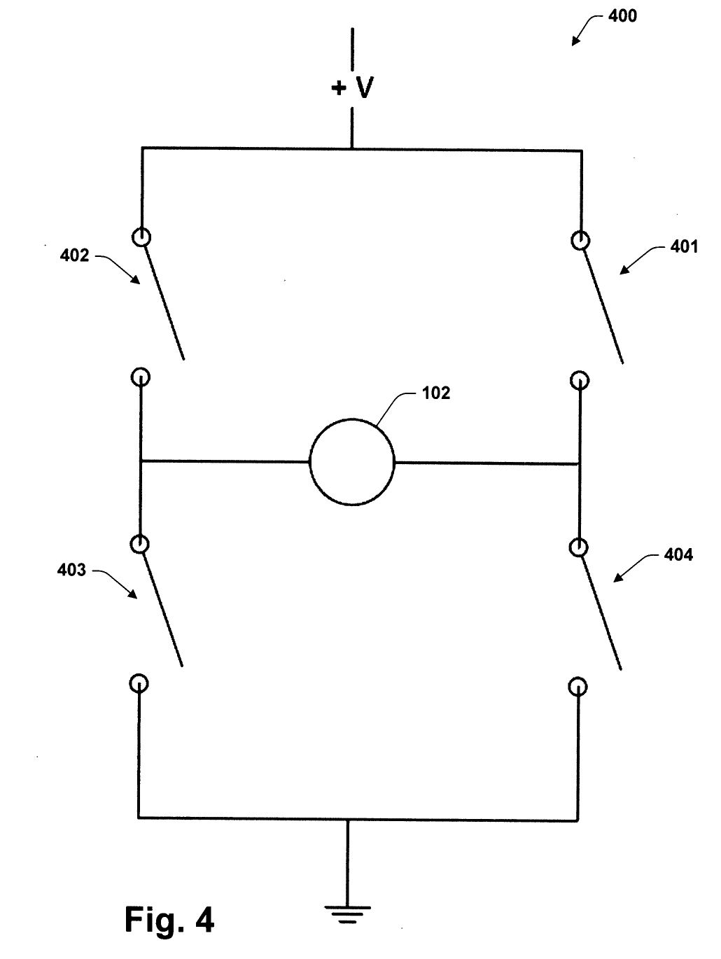

FIG. 4 is a diagram of an exemplary circuit 400 that can be used to control the solenoid vale 100. The circuit 400 comprises four switches, switches 401, 402, 403, and 404. When the switches 401 and 403 are closed and the switches 402 and 404 are open, current flows in a primary direction across the coil 102. When the switches 401 and 403 are open and the switches 402 and 404 are closed, current flows in a reverse direction across the coil 102.

The exemplary valve 100 is designed to be cooled using an excess reductant flow. Even when the valve 100 is closed, fuel flows from the inlet 110 through passages 109 in the pintel 105, through passage 113, which is concentric with the spool 103, past check-valve 112, and through outlet 114. The check-valve 112 maintains the pressure within the fuel pressure within the valve body 103 by only passing fuel when the pressure is above a critical valve. Fuel from the outlet 114 may be returned to a fuel reservoir. The returning fuel carries heat away from the valve 100.

Alternatively, the valve 100 can be cooled by other means. In one example, a fuel flow circuit separate from the fuel dosing circuit is provided to cool the valve 100. In another example, another cooling fluid, such as engine coolant, is circulated through the valve body 103 to keep the valve 100 cool.

The duty cycle of the valve 100 can be determined in any suitable manner. The duty cycle and lift for the valve 100, where variable, can be set by the controller 12 to meet demands for reductant dosing provided by the controller 55. The controller 12 may consider the supply pressure in setting these parameters. In general, the flow rate through the valve 100 is proportional to the pressure drop across the spray orifice 107. As the pressure in the exhaust line 30 is often substantially constant, the supply pressure is the main consideration. The supply pressure may be regulated to a large extent by the check-valve 112. Nevertheless, it may be desirable to measure the pressure using the sensor 11 and to use the measured pressure in determining an appropriate duty cycle for delivering a demanded dosing rate.

The reductant dosing system 100 is not the only configuration in which the inventors concepts can be applied. For example, the flow control 100 can be placed some distance from the exhaust line 30 and connected to the exhaust line 30 through a conduit. In such a configuration, the nozzle spraying reductant into the exhaust line 30 generally comprises a check-valve. The advantage of such a configuration is that many of the dosing system parts are protected from the more extreme exhaust temperatures.

In operation of the power generation system 40, from time-to-time the controller 50 determines that the DPF 52 needs to be regenerated to remove accumulated particulate matter. This determination is generally made based on a rising pressure drop of the exhaust across the DPF 52. Regeneration is initiated by dosing fuel into the exhaust line 30 at a sub-stoichiometric rate. The injected fuel combusts in the fuel reformer 51, generating heat that eventually brings the DPF 52 to a temperature at which the particulate matter trapped on the DPF 52 begins to combust. Particulate matter combustion is exothermic and soon becomes self-sustaining, at which point fuel injection is generally stopped.

From time-to-time, the LNT 53 must be regenerated to remove accumulated NO_{X} (denitrated) in a rich phase. Denitration generally involves heating the reformer 51 to an operational temperature and then using the reformer 51 to produce reformate. The reformer 51 is generally heated by injecting fuel into the exhaust upstream from the fuel reformer 51 using the fuel dosing system 1 at a sub-stoichiometric rate, whereby the exhaust-reductant mixture remains overall lean and most of the injected fuel completely combusts in the reformer 51. This may be referred to as a lean warm-up phase. Once combustion has heated the reformer 51, the fuel injection rate can be increased to make the exhaust-reductant mixture overall rich, whereupon the reformer 51 consumes most of the oxygen from the exhaust and produces reformate by partial oxidation and steam reforming reactions. The reformate thus produced reduces NO_{X} absorbed in the LNT 53. Some of the NO_{X} may be reduced to NH₃, which is absorbed and stored by the ammonia-SCR catalyst 54.

From time to time, the LNT 53 must be regenerated to remove accumulated sulfur compounds (desulfated). Desulfation involves heating the fuel reformer 51 to an operational temperature, heating the LNT 53 to a desulfating temperature, and providing the heated LNT 53 with a rich atmosphere. Desulfating temperatures vary, but are typically in the range from about 500 to about 800° C., with optimal temperatures typically in the range of about 650 to about 750° C. Below a minimum temperature, desulfation is very slow. Above a maximum temperature, the LNT 53 may be damaged.

Denitration and desulfation scheduling are carried out by the controller 55, which provides a control signal once the criteria for initiating a denitration have been met. The controller 55 may also provide a control signal once criteria marking the end of denitration have been met. Criteria for initiating denitration of the LNT 51 generally relate to the state and or NO_{X} mitigating performance of the exhaust aftertreatment system 42 or a portion thereof comprising the LNT 53. A state of the exhaust aftertreatment system 42 can relate to the NO_{X} loading or remaining NO_{X} storage capacity of the LNT 53. The point of initiating denitration may be varied to advance the timing of denitration when conditions are opportune for denitrating or to postpone denitration when the current level of demand for NO_{X} mitigation created by the engine 43 is below peak.

Criteria for initiating desulfation generally relate to the state of the LNT 53. In one example, desulfation is initiated based on an estimate of the amount of sulfur stored in the LNT 53. The amount of accumulated sulfur can be estimated, for example, by integrating the product of an estimate of the engine 43's SO_{X} production rate by an estimate of the LNT 53's SO_{X} adsorption efficiency. The engine 43's SO_{X} production rate can be estimated based on the amount of fuel consumed. In another example, desulfation is initiated after a fixed period of engine operation, or after a fixed number of denitrations. In a further example, desulfation is initiating based on the NO_{X} mitigation performance of the exhaust aftertreatment system 43 or some portion thereof comprising the LNT 53 having fallen to some critical level. As with denitration, the point of initiating desulfation may be varied to advance the timing of desulfation when conditions are opportune for desulfating or to postpone desulfation when the current level of demand for NO_{X} mitigation created by the engine 43 is below peak. Conditions are generally considered opportune when the LNT 53 can be desulfated with a comparatively low fuel penalty. For example, it is often opportune to denitrate the LNT 53 when normal engine operation is resulting in a period of comparatively low exhaust oxygen flow rate.

Desulfating the LNT 53 involves heating the LNT 53 to desulfation temperatures and providing the LNT 53 with an overall rich reductant-exhaust mixture. A primary mechanism of heating the LNT 53 is heat convection from the fuel reformer 51; the fuel reformer 51 is heated and the exhaust gas is allowed to carry the heat downstream to the LNT 51. Such heating of the LNT 51 is generally mitigated during denitration by the positioning the DPF 52 between the reformer 51 and the LNT 53. Of course, the DPF 52 need not be provided in this position.

The LNT 53 may also be heated in part by combustion within the LNT 53. Such combustion can occur through the reaction of reductants provided to the LNT 53 under overall rich conditions with oxygen provided to the LNT 105 under overall lean conditions. Reductants, such as syn gas and unreformed or partially reformed fuel, slip to the LNT 53 during rich phases. These reductants can react during the rich phases with oxygen stored in the LNT 53 from a previous lean phase. This mechanism can be promoted by providing the LNT 53 with oxygen storage capacity. Alternatively or in addition, reductants can be adsorbed and stored in the LNT 53 during the rich phase and react with oxygen provided to the LNT 53 during the lean phases. Large hydrocarbons are better candidates for adsorption and storage than syn gas. This mechanism can be promoted by providing the LNT 53 with hydrocarbon adsorption capacity. Allowing some hydrocarbon slip from the fuel reformer 51 can be desirable in promoting this mechanism. Other mechanisms may result in combustion, including mixing of gases from lean and rich phases and storage of reductants or oxygen on walls or other locations upstream from the LNT Regardless of the mechanism, the extent of heating by combustion within the LNT 53 is susceptible to control through the frequency of transition between lean and rich phases.

The pulsing of fuel injection to alternate between lean and rich phases, which causes combustion and heating in the LNT 53, is desirable during desulfation for several reasons. Pulsing is desirable as a way of controlling the rate at which the fuel reformer 51 heats and as a way of mitigating H₂S release from the LNT 53. Pulsing is further desirable in that it can be used to control the temperature of the LNT 53 independently from the temperature of the fuel reformer 51. If desired, the LNT 53 can be operated at a higher temperature than the fuel reformer 51, whereby the fuel reformer 51 can be operated in a temperature range most suited to its preservation and performance while the LNT 105 can be operated in a temperature range most suited to its preservation and desulfation.

Each of these processes depends on reliable opening and closing of the flow control valve 100. If an instruction is issued to close the valve 100, but the valve does not close due to improper seating, a variety of consequences can ensue, depending on the circumstances. Any of the reformer 51, the DPF 52, the LNT 53, or the SCR catalyst 54 can be overheated. Reductant can break through from the LNT 53, polluting the environment or poisoning the SCR catalyst 54. Excess reductant can also result in H₂S emissions or excessive cooling of the fuel reformer 51.

The fuel reformer 51 is a device that converts heavier hydrocarbons into lighter compounds without fully combusting the hydrocarbon. The fuel reformer 51 can be a catalytic reformer or a plasma reformer. Preferably, the fuel reformer 51 is a partial oxidation catalytic reformer comprising a steam reforming catalyst. Preferably, the fuel reformer 51 comprises separate oxidation and steam reforming washcoats. Examples of reformer catalysts include precious metals, such as Pt, Pd, and Rh. The fuel reformer 51 is preferably small compared to an oxidation catalyst that is designed to perform its primary functions at temperatures below 450° C. The reformer 51 is generally operative at temperatures within the range of about 450 to about 1100° C.

The LNT 53 can comprise any suitable NOx-adsorbing material. Examples of NOx adsorbing materials include, without limitation, oxides, carbonates, and hydroxides of alkaline earth metals such as Mg, Ca, Sr, and Ba or alkali metals such as K or Cs. Generally, the NOx-adsorbing material is an alkaline earth oxide. The adsorbent is typically combined with a binder and either formed into a self-supporting structure or applied as a coating over an inert substrate.

The LNT 53 also comprises a catalyst for the reduction of NOx in a reducing environment. The catalyst can be, for example, one or more transition metals, such as Au, Ag, and Cu, group VIII metals, such as Pt, Rh, Pd, Ru, Ni, and Co, Cr, or Mo. A typical catalyst includes Pt and Rh. Precious metal catalysts also facilitate the adsorbent function of alkaline earth oxide absorbers.

The ammonia-SCR catalyst 54 is functional to catalyze reactions between NOx and NH3 to reduce NOx to N2 in lean exhaust. Examples of SCR catalysts include some oxides of metals such as Cu, Zn, V, Cr, Al, Ti, Mn, Co, Fe, Ni, Pd, Pt, Rh, Mo, W, and Ce, and some zeolites, such as ZSM-5 or ZSM-11, substituted with metal ions such as cations of Cu, Co, Ag, Zn, or Pt. Preferably, the ammonia-SCR catalyst 54 is designed to tolerate temperatures required to desulfate the LNT 53.

The invention as delineated by the following claims has been shown and/or described in terms of certain concepts, components, and features. While a particular component or feature may have been disclosed herein with respect to only one of several concepts or examples or in both broad and narrow terms, the components or features in their broad or narrow conceptions may be combined with one or more other components or features in their broad or narrow conceptions wherein such a combination would be recognized as logical by one of ordinary skill in the art. Also, this one specification may describe more than one invention and the following claims do not necessarily encompass every concept, aspect, embodiment, or example described herein.

1. A method of operating an exhaust line dosing system, wherein the exhaust line dosing system comprises:
a pulse width modulated solenoid valve, comprising
a valve body;
an orifice;
a valve seat surrounding the orifice;
a sealing member configured to move within the valve body between a lowered first position in which the sealing member engages the valve seat to seal off the orifice and a second position in which the sealing member is lifted from the valve seat allowing reductant under pressure within the valve body to release through the orifice;
a spring that biases the sealing member toward the first position;
a permanent magnet integral with or attached to the sealing member; and
an electrical coil that when powered with a direct current in a primary direction maintains a magnetic field that exerts a force on the permanent magnet that lifts the sealing member away from the first position and toward the second position;
the method comprising:
controlling the duty cycle of the pulse width modulated solenoid valve to dose reductant from a pressurized source through the orifice; and
applying a direct current to the electrical coil in a reverse direction from the primary direction in order to ensure that the sealing member properly engages the valve seat.

2. The method of claim 1, wherein the electrical coil is energized with the reverse current while the sealing member is in a fully lowered position.

3. The method of claim 1, wherein the electrical coil is energized with the reverse current while the sealing member is lifted from the valve seat and is maintained until after the sealing member has engaged the valve seat.

4. The method of claim 1, wherein the reverse current is maintained for an extended period, which is a period at least one second in length.

5. The method of claim 1, wherein the reverse current does not significantly accelerate the valve closing.

6. The method of claim 1, wherein the application of the reverse current has no significant effect one the valve turn-down ratio.

7. The method of claim 1, wherein the voltage driving the current in the primary direction is adjusted to regulate the magnitude of the valve lift.

8. The method of claim 1, wherein the magnitude of the voltage driving the current in the primary direction is adjusted to help control the flow rate through the valve.

9. The method of claim 1, wherein the current is reversed using a polarity switch.

10. The method of claim 1, wherein the dosing system is used in a power generation system to inject fuel into an engine stream.

11. The method of claim 1, wherein the valve lift is about 250 microns or less.

12. The method of claim 1, wherein the duty cycle is from about 10 to about 200 hertz.

13. The method of claim 1, wherein the flow rate through the valve is controlled to within the range from about 20 to about 1200 g/min.

14. The method of claim 1, wherein the reductant is pressurized in the range from about 1.5 to about 10.0 bar.

15. The method of claim 1, further comprising cooling the valve by flowing reductant through the valve body in excess of the reductant that is passed through the orifice.

16. The method of claim 1, wherein the reverse current significantly increases the consistency with which the sealing member properly engages the valve seat.

17. The method of claim 1, wherein use of the reverse current significantly reduces leakage of reductant from the valve.
